(19) United States
(12) Patent Application Publication
(10) Pub. No.: US 2018/0329675 A1
(43) Pub. Date: Nov. 15, 2018

(54) ELECTRONIC DEVICE AND METHOD FOR CONTROLLING AUDIO OUTPUT ACCORDING TO THE TYPE OF EARPHONE

(71) Applicant: Samsung Electronics Co., Ltd., Gyeonggi-do (KR)

(72) Inventors: Byeongmin LEE, Gyeonggi-do (KR); Minju SEO, Gyeonggi-do (KR); Jeock LEE, Gyeonggi-do (KR); Juhee CHANG, Gyeonggi-do (KR); Seonmi KIM, Gyeonggi-do (KR); Taiyong KIM, Gyeonggi-do (KR); Hochul HWANG, Gyeonggi-do (KR)

(21) Appl. No.: 15/968,985

(22) Filed: May 2, 2018

(30) Foreign Application Priority Data
May 10, 2017 (KR) 10-2017-0058199

(51) Int. Cl. G06F 3/16; G06F 3/0484; H04R 3/00; H04R 1/10

(52) U.S. Cl. CPC G06F 3/165; G06F 3/04847; G06F 3/0488; H04R 1/1041; H04R 3/00

(57) ABSTRACT

An electronic device and method for identifying the type of earphone and controlling audio output based on the identified type of the earphone. The electronic device includes an interface configured to detect an input of an earphone having a first audio output module with a first impedance value and a second audio output module with a second impedance value, and a processor configured to control the interface to detect the input of the earphone, check the first impedance value of the first audio output module and the second impedance value of the second output module, determine a type of the earphone based on at least the first and second impedance values, and adjust a characteristic related to the audio output of the electronic device based on the determined type of the earphone.

### CROSS-REFERENCE TO RELATED APPLICATION(S)

This application claims priority under 35 U.S.C. § 119(a) to Korean Patent Application No. 10-2017-0058199, filed on May 10, 2017, in the Korean Intellectual Property Office, the disclosure of which is incorporated herein by reference in its entirety.

### TECHNICAL FIELD

The present disclosure relates to an electronic device and a method for controlling the audio output of the electronic device.

### BACKGROUND

An electronic device, such as a portable terminal (e.g., smartphone), may provide a user with various functions.

For example, the electronic device may process audio files that are in various formats to output audio signals.

The user of the electronic device may insert a jack plug of an audio output device (e.g., an earphone, a headphone, or a speaker) into a jack socket of the electronic device to listen to the sound that is outputted by the electronic device.

The jack socket of the electronic device may be configured to receive a 3-pole or a 4-pole jack plug of an earphone that includes a left audio output module and a right audio output module.

### SUMMARY

However, the conventional electronic device cannot distinguish between different types of earphones. This is because the impedance values of the left and right audio output modules of the earphone are identical to each other and, therefore, cannot be used as a means to provide other functionalities.

The present disclosure provides an electronic device and method for identifying a predetermined type of earphone based on, for example, the impedance of the first audio output module (e.g., left) and the second audio output module (e.g., right), which may be set to different values. After the earphone type is identified, the electronic device and method may output audio signals that are optimized for the identified type of earphone.

Also, the present disclosure provides a non-transitory computer-readable recording medium for recording a program which, when executed, performs the method of identifying a predetermined type of earphone and controlling the audio output using the electronic device.

In accordance with an aspect of the present disclosure, an electronic device is provided. The electronic device may include an interface that is configured to detect the input of an earphone having a first audio output module with a first impedance value and a second audio output module with a second impedance value. The electronic device may also include a processor that is configured to control the interface to detect the input of the earphone, check the first impedance value of the first audio output module and the second impedance value of the second output module, determine a type of the earphone based on at least the first and second impedance values, and adjust a characteristic related to the audio output of the electronic device based on the determined type of earphone.

In accordance with another aspect of the present disclosure, a method for controlling audio output is provided. The method includes detecting, by a processor, using an interface, an input of an earphone having a first audio output module with a first impedance value and a second audio output module with a second impedance value; checking, by the processor, the first impedance value of the first audio output module and the second impedance value of the second output module; determining, by the processor, a type of the earphone based on at least the first and second impedance values; and adjusting, by the processor, a characteristic related to the audio output of the electronic device based on the determined type of earphone.

In accordance with still another aspect of the present disclosure, provided is a non-transitory computer-readable recording medium that stores a program for performing a method of controlling the audio output of an electronic device. The method includes detecting, using an interface, an input of an earphone having a first audio output module with a first impedance value and a second audio output module with a second impedance value, checking the first impedance value of the first audio output module and the second impedance value of the second output module, determining a type of the earphone based on at least the first and second impedance values, and adjusting a characteristic related to the audio output of the electronic device based on the determined type of the earphone.

### BRIEF DESCRIPTION OF THE DRAWINGS

FIG. 1 is a diagram illustrating a network environment including electronic devices according to various embodiments of the present disclosure;

FIG. 2 is a block diagram illustrating an electronic device according to various embodiments of the present disclosure;

FIG. 3 is a diagram illustrating a program module according to various embodiment of the present disclosure;

FIG. 4 is a schematic diagram illustrating one possible configuration of an earphone and an electronic device according to an embodiment of the present disclosure;

FIG. 5 is a block diagram illustrating one possible configuration of an electronic device according to various embodiments of the present disclosure;

FIG. 6 is a diagram illustrating a possible connection relationship between an earphone and an electronic device according to various embodiments of the present disclosure;

FIG. 7 is a diagram illustrating a possible audio output characteristic when impedance values of the first and second audio output modules of an earphone are identical to each other according to various embodiments of the present disclosure;

FIG. 8 is a diagram illustrating a possible audio output characteristic when a difference between the impedance values of the first and second audio output modules of an earphone falls within a first range according to various embodiments of the present disclosure;

FIG. 9 is a diagram illustrating one possible audio output characteristic when a difference between the impedance values of the first and second audio output modules of an earphone falls within a second range according to various embodiments of the present disclosure;

FIG. 10 is a diagram illustrating an exemplary screen display presenting a type of an earphone that is connected to an electronic device according to various embodiments of the present disclosure;

FIG. 11 is a diagram illustrating an exemplary screen display during the adjustment of audio output in dependence on the type of earphone connected to an electronic device according to various embodiments of the present disclosure;

FIG. 12 is a flowchart illustrating an exemplary method for controlling audio output characteristics in dependence on the type of earphone connected to an electronic device according to various embodiments of the present disclosure; and

FIG. 13 is a flowchart illustrating another exemplary method for controlling audio output characteristics in dependence on the type of earphone connected to an electronic device according to various embodiments of the present disclosure.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The terms “have,” “may have,” “include,” and “may include” as used herein indicate the presence of corresponding features (for example, elements such as numerical values, functions, operations, or parts), and do not preclude the presence of additional features.

The terms “A or B,” “at least one of A or/and B,” or “one or more of A or/and B” as used herein include all possible combinations of items enumerated with them. For example, “A or B,” “at least one of A and B,” or “at least one of A or B” means (1) including at least one A, (2) including at least one B, or (3) including both at least one A and at least one B.

The terms such as “first” and “second” as used herein may modify various elements regardless of an order and/or importance of the corresponding elements, and do not limit the corresponding elements. These terms may be used for the purpose of distinguishing one element from another element. For example, a first user device and a second user device may indicate different user devices regardless of the order or importance. For example, a first element may be referred to as a second element without departing from the scope the present disclosure, and similarly, a second element may be referred to as a first element.

It will be understood that, when an element (for example, a first element) is “(operatively or communicatively) coupled with/to” or “connected to” another element (for example, a second element), the element may be directly coupled with/to another element, and there may be an intervening element (for example, a third element) between the element and another element. To the contrary, it will be understood that, when an element (for example, a first element) is “directly coupled with/to” or “directly connected to” another element (for example, a second element), there is no intervening element (for example, a third element) between the element and another element.

The expression “configured to (or set to)” as used herein may be used interchangeably with “suitable for,” “having the capacity to,” “designed to,” “ adapted to,” “made to,” or “capable of” according to a context. The term “configured to (set to)” does not necessarily mean “specifically designed to” in a hardware level. Instead, the expression “apparatus configured to . . . ” may mean that the apparatus is “capable of . . . ” along with other devices or parts in a certain context. For example, “a processor configured to (set to) perform A, B, and C” may mean a dedicated processor (e.g., an embedded processor) for performing a corresponding operation, or a generic-purpose processor (e.g., a central processing unit (CPU) or an application processor) capable of performing a corresponding operation by executing one or more software programs stored in a memory device.

The terms used in describing various embodiments of the present disclosure are for the purpose of describing particular embodiments and are not intended to limit the present disclosure. As used herein, the singular forms are intended to include the plural forms as well, unless the context clearly indicates otherwise. All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the present disclosure.

Electronic devices according to embodiments of the present disclosure may include at least one of, for example, smart phones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to an embodiment of the present disclosure, the wearable devices may include at least one of accessory-type wearable devices (e.g., watches, rings, bracelets, anklets, necklaces, glasses, contact lenses, or head-mounted-devices (HMDs)), fabric or clothing integral wearable devices (e.g., electronic clothes), body-mounted wearable devices (e.g., skin pads or tattoos), or implantable wearable devices (e.g., implantable circuits).

The electronic devices may be smart home appliances. The smart home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ and PlayStation™), electronic dictionaries, electronic keys, camcorders, or electronic picture frames.

The electronic devices may include at least one of various medical devices (e.g., various portable medical measurement devices (such as blood glucose meters, heart rate monitors, blood pressure monitors, or thermometers, and the like), a magnetic resonance angiography (MRA) device, a magnetic resonance imaging (MRI) device, a computed tomography (CT) device, scanners, or ultrasonic devices, and the like), navigation devices, global positioning system (GPS) receivers, event data recorders (EDRs), flight data recorders (FDRs), vehicle infotainment devices, electronic equipment for vessels (e.g., navigation systems, gyrocompasses, and the like), avionics, security devices, head units for vehicles, industrial or home robots, automatic teller machines (ATMs), points of sales (POSs) devices, or Internet of Things (IoT) devices (e.g., light bulbs, various sensors, electric or gas meters, sprinkler devices, fire alarms, thermostats, street lamps, toasters, exercise equipment, hot water tanks, heaters, boilers, and the like).

The electronic devices may further include at least one of parts of furniture or buildings/structures, electronic boards, electronic signature receiving devices, projectors, or various measuring instruments (such as water meters, electricity meters, gas meters, or wave meters, and the like). The electronic devices may be one or more combinations of the above-mentioned devices. The electronic devices may be flexible electronic devices. Also, the electronic devices are not limited to the above-mentioned devices and may include new electronic devices according to the development of new technologies.

Hereinafter, electronic devices according to various embodiments of the present disclosure will be described with reference to the accompanying drawings. The term “user” as used herein may refer to a person who uses an electronic device or may refer to a device (e.g., an artificial intelligence electronic device) which uses an electronic device.

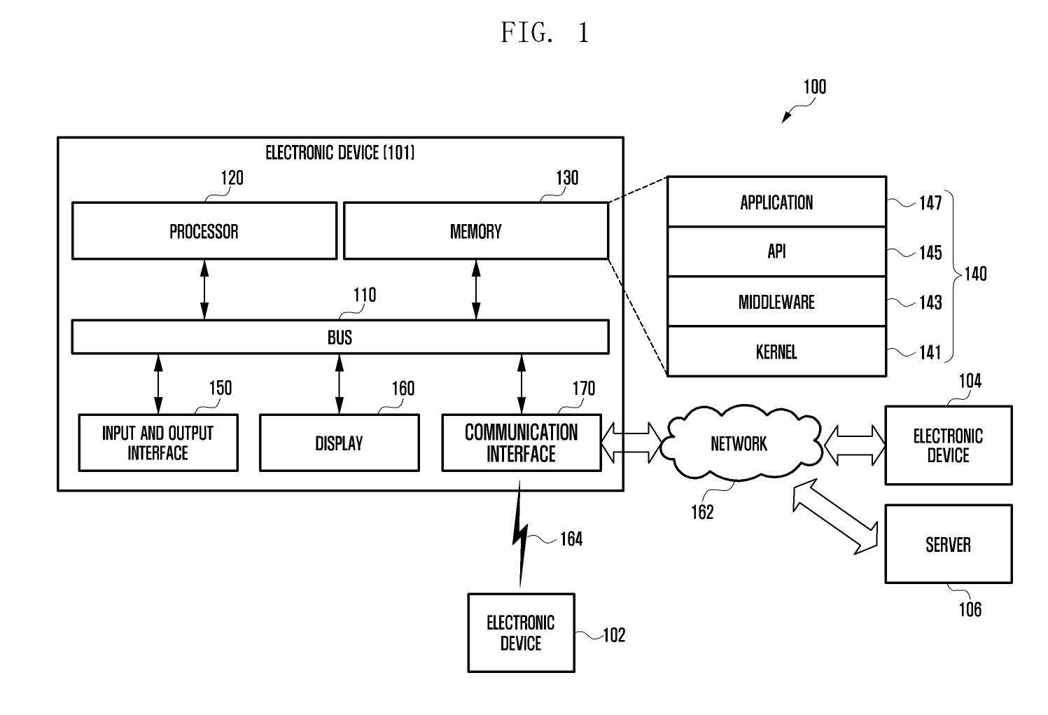

FIG. 1 illustrates a network environment including an electronic device according to an embodiment of the present disclosure.

Referring to FIG. 1, a network environment 100 includes an electronic device 101 having a bus 110, a processor 120, a non-transitory memory 130, an input/output interface 150, a display 160, and a communication interface 170. At least one of the above described components may be omitted from the electronic device 101 or another component may be further included in the electronic device 101.

The bus 110 may be a circuit connecting the above described components 120, 130, and 150-170 and may transmit communications (e.g., control messages and/or data) between the above described components. The processor 120 may include one or more of a CPU, an application processor (AP), and a communication processor (CP). The processor 120 is capable of controlling at least one of the components of electronic device 101 and/or processing data or operations that are related to communications.

The non-transitory memory 130 may include volatile memory and/or non-volatile memory. The memory 130 is capable of storing data or commands related to at least one of the components of the electronic device 101. The non-transitory memory 130 is capable of storing software and/or a program module 140. For example, the program 140 may include a kernel 141, middleware 143, an application programming interface (API) 145, application programs (or applications) 147, etc. The kernel 141, the middleware 143 or at least part of the API 145 may be called an operating system (OS).

The kernel 141 is capable of controlling or managing system resources (e.g., the bus 110, the processor 120, the memory 130, etc.) used to execute operations or functions of other programs (e.g., the middleware 143, the API 145, and the application programs 147). The kernel 141 provides an interface capable of allowing the middleware 143, the API 145, and the application programs 147 to access and control/manage the individual components of the electronic device 101.

The middleware 143 may be an interface between the API 145 or the application programs 147 and the kernel 141 so that the API 145 or the application programs 147 can communicate with the kernel 141 and exchange data therewith. The middleware 143 is capable of processing one or more tasks or requests received from the application programs 147 according to the priority. For example, the middleware 143 is capable of assigning a priority to at least one of the application programs 147 for using the system resources of the electronic device 101 (e.g., the bus 110, the processor 120, the memory 130, etc.). For example, the middleware 143 processes one or more tasks or requests according to a priority assigned to at least one application program, thereby performing scheduling or load balancing for the tasks or requests.

The API 145 may be an interface that is configured to allow the application programs 147 to control functions provided by the kernel 141 or the middleware 143. The API 145 may include at least one interface or function (e.g., instructions) for file control, window control, image process, text control, or the like.

The input/output interface 150 is capable of transferring instructions or data, received from the user or external devices, to one or more components of the electronic device 101. The input/output interface 150 is capable of outputting instructions or data, received from one or more components of the electronic device 101, to the user or external devices.

The display 160 may include a liquid crystal display (LCD), a flexible display, a transparent display, a light emitting diode (LED) display, an organic LED (OLED) display, micro-Electro-mechanical systems (MEMS) display, an electronic paper display, etc. The display 160 is capable of displaying various types of content (e.g., texts, images, videos, icons, symbols, etc.). The display 160 may also be implemented with a touch screen. In this case, the display 160 is capable of receiving touches, gestures, proximity inputs or hovering inputs, via a stylus pen, or a user's body.

The communication interface 170 is capable of establishing communication between the electronic device 101 and an external device. For example, the communication interface 170 is capable of communicating with an external device connected to a network 162 via wired or wireless communication.

Wireless communication may employ, as cellular communication protocol, at least one of long-term evolution (LTE), LTE Advance (LTE-A), code division multiple access (CDMA), wideband CDMA (WCDMA), universal mobile telecommunications system (UMTS), wireless broadband (WiBro), and global system for mobile communication (GSM). Wireless communication may also include short-wireless communication 164. Short-wireless communication 164 may include at least one of wireless fidelity (Wi-Fi), Bluetooth (BT), near field communication (NFC), magnetic secure transmission (MST), and global navigation satellite system (GNSS). The GNSS may include at least one of GPS, global navigation satellite system (Glonass), Beidou NSS (Beidou), Galileo, the European global satellite-based navigation system, according to GNSS using areas, bandwidths, etc. In the present disclosure, “GPS” and “GNSS” may be used interchangeably. Wired communication may include at least one of universal serial bus (USB), high definition multimedia interface (HDMI), recommended standard 232 (RS-232), and plain old telephone service (POTS). The network 162 may include at least one of the following: a telecommunications network, e.g., a computer network (e.g., local area network (LAN) or wide area network (WAN)), the Internet, and a telephone network.

A first external electronic device 102 and a second external electronic device 104 are each identical to or different from the electronic device 101, in terms of type. According to an embodiment, a server 106 is capable of including a group of one or more servers. According to various embodiments, part of or all of the operations executed on the electronic device 101 may be executed on another electronic device or a plurality of other electronic devices (e.g., electronic devices 102 and 104 or a server 106). According to an embodiment, when the electronic device needs to perform a function or service automatically or according to a request, it does not perform the function or service, but is capable of additionally requesting at least part of the function related to the function or service from another electronic device (e.g., electronic devices 102 and 104 or a server 106). The other electronic device (e.g., electronic devices 102 and 104 or a server 106) is capable of executing the requested function or additional functions and transmitting the result to the electronic device 101. The electronic device 101 processes the received result, or further proceeds with additional processes, to provide the requested function or service. To this end, the electronic device 101 may employ cloud computing, distributed computing, or client-server computing technology.

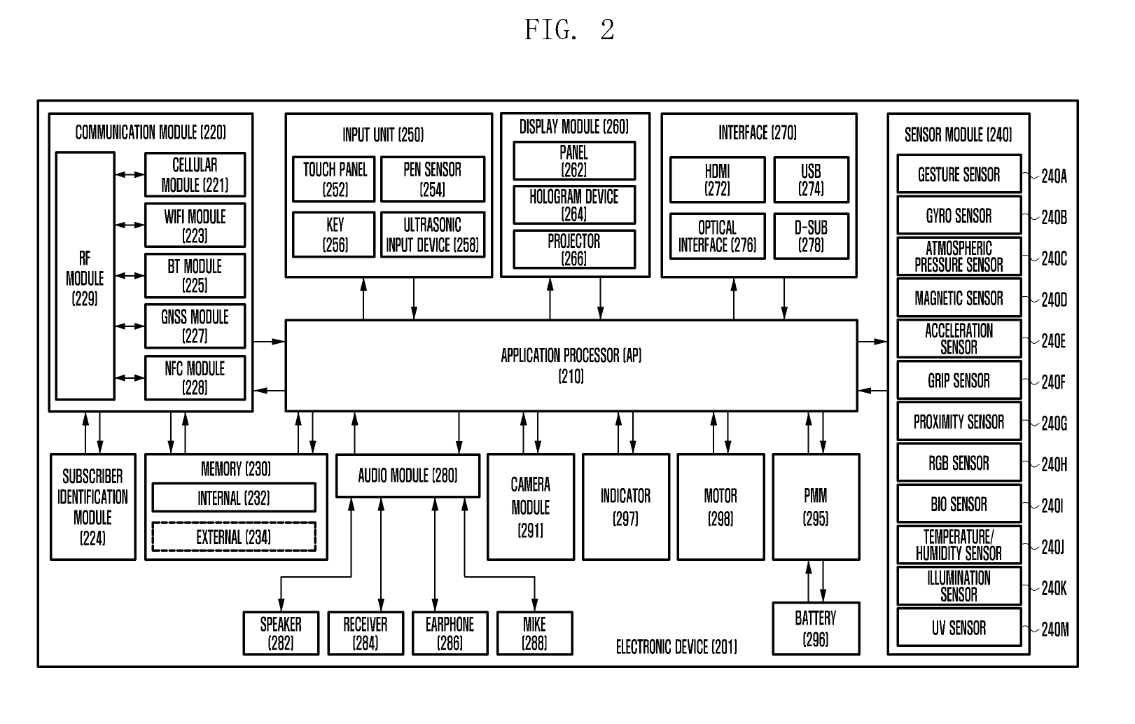

FIG. 2 is a block diagram showing one possible configuration of an electronic device according to an embodiment of the present disclosure.

Referring to FIG. 2, an electronic device 201 may include a part of or all of the components in the electronic device 101 shown in FIG. 1. The electronic device 201 may include one or more processors 210 (e.g., APs), a communication module 220, a subscriber identification module (SIM) 224, a non-transitory memory 230, a sensor module 240, an input device 250, a display 260, an interface 270, an audio module 280, a camera module 291, a power management module 295, a battery 296, an indicator 297, and a motor 298.

The processor 210 is capable of driving, for example, an operating system or an application program to control a plurality of hardware or software components connected to the processor 210, processing various data, and performing operations. The processor 210 may be implemented as, for example, a system on chip (SoC). The processor 210 may further include a graphic processing unit (GPU) and/or an image signal processor. The processor 210 may also include at least part of the components shown in FIG. 2, e.g., a cellular module 221. The processor 210 is capable of loading commands or data received from at least one other component (e.g., a non-volatile memory) on a volatile memory and processing the loaded commands or data. The processor 210 is capable of storing various data in a non-volatile memory.

The communication module 220 may include the same or similar configurations as the communication interface 170 shown in FIG. 1. For example, the communication module 170 is capable of including the cellular module 221, a Wi-Fi module 223, a Bluetooth (BT) module 225, a GNSS module 227 (e.g., a GPS module, Glonass module, Beidou module or Galileo module), an NFC module 228, and a radio frequency (RF) module 229.

The cellular module 221 is capable of providing a voice call, a video call, an SMS service, an Internet service, etc., through a communication network, for example. The cellular module 221 is capable of identifying and authenticating an electronic device 201 in a communication network by using the SIM 224. The cellular module 221 is capable of performing at least part of the functions provided by the processor 210. The cellular module 221 may include a CP.

Each of the Wi-Fi module 223, the BT module 225, the GNSS module 227, and the NFC module 228 may include a processor for processing data transmitted or received through the corresponding module. At least part of the cellular module 221, Wi-Fi module 223, BT module 225, GNSS module 227, and NFC module 228 (e.g., two or more modules) may be included in one integrated chip (IC) or one IC package.

The RF module 229 is capable of transmission/reception of communication signals, e.g., RF signals. The RF module 229 is capable of including a transceiver, a power amplifier module (PAM), a frequency filter, a low noise amplifier (LNA), an antenna, etc. At least one of the cellular module 221, the Wi-Fi module 223, the BT module 225, the GNSS module 227, and the NFC module 228 is capable of transmission/reception of RF signals through a separate RF module. The non-transitory memory 230 may include a built-in memory 232 or an external memory 234. The built-in memory 232 is capable of including at least one of a volatile memory, e.g., a dynamic random access memory (DRAM), a static RAM (SRAM), a synchronous dynamic RAM (SDRAM), etc. and a non-volatile memory, e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory, an NOR flash memory, etc.), a hard drive, a solid state drive (SSD), etc.

The external memory 234 may include a flash drive, e.g., a compact flash (CF), a secure digital (SD), a micro secure digital (Micro-SD), a mini secure digital (Mini-SD), an extreme digital (xD), a multi-media card (MMC), a memory stick, etc. The external memory 234 may be connected to the electronic device 201, functionally and/or physically, through various interfaces.

The sensor module 240 is capable of measuring/detecting a physical quantity or an operation state of the electronic device 201 and converting the measured or detected information into an electronic signal. The sensor module 240 may include at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (e.g., a red, green and blue (RGB) sensor), a biometric sensor 240I, a temperature/humidity sensor 240J, an illuminance sensor 240K, and a ultraviolet (UV) sensor 240M. Additionally or alternatively, the sensor module 240 may also include an e-nose sensor, an electromyography (EMG) sensor, an electroencephalogram (EEG) sensor, an electrocardiogram (ECG) sensor, an infrared (IR) sensor, an iris sensor and/or a fingerprint sensor. The sensor module 240 may further include a control circuit for controlling one or more sensors included therein. The electronic device 201 may include a processor, configured as part of the processor 210 or a separate component, for controlling the sensor module 240.

In this case, while the processor 210 is operating in sleep mode, the processor is capable of controlling the sensor module 240.

The input device 250 may include a touch panel 252, a (digital) pen sensor 254, a key 256, or an ultrasonic input unit 258. The touch panel 252 may be implemented with at least one of a capacitive touch system, a resistive touch system, an infrared touch system, and an ultrasonic touch system. The touch panel 252 may further include a control circuit, and the touch panel 252 may include a tactile layer to provide a tactile response to the user. The (digital) pen sensor 254 may be implemented with a part of the touch panel or with a separate recognition sheet. The key 256 may include a physical button, an optical key, or a keypad. The ultrasonic input unit 258 is capable of detecting ultrasonic waves, created in an input tool, through a microphone 288, and identifying data corresponding to the detected ultrasonic waves.

The display 260 may include a panel 262, a hologram unit 264, or a projector 266. The panel 262 may include the same or similar components as the display 160 shown in FIG. 1. The panel 262 may be implemented to be flexible, transparent, or wearable. The panel 262 may also be incorporated into one module together with the touch panel 252. The hologram unit 264 is capable of showing a stereoscopic image in the air by using light interference. The projector 266 is capable of displaying an image by projecting light onto a screen. The screen may be located inside or outside of the electronic device 201. The display 260 may further include a control circuit for controlling the panel 262, the hologram unit 264, or the projector 266.

The interface 270 may include an HDMI 272, a USB 274, an optical interface 276, or a d-subminiature (D-sub) 278.

The interface 270 may be included in the communication interface 170 shown in FIG. 1. Additionally or alternatively, the interface 270 may include a mobile high-definition link (MHL) interface, a SD card/MMC interface, or an infrared data association (IrDA) standard interface.

The audio module 280 is capable of providing bidirectional conversion between a sound and an electronic signal. At least part of the components in the audio module 280 may be included in the input/output interface 150 shown in FIG. 1. The audio module 280 is capable of processing sound information input or output through a speaker 282, a receiver 284, earphones 286, a microphone 288, etc.

The camera module 291 is a device capable of taking both still and moving images. The camera module 291 may include one or more image sensors (e.g., a front image sensor or a rear image sensor), a lens, an image signal processor (ISP), a flash (e.g., an LED or xenon lamp), etc.

The power management module 295 is capable of managing power of the electronic device 201. The power management module 295 may include a power management integrated circuit (PMIC), a charger IC, or a battery gauge. The PMIC may employ wired charging and/or wireless charging methods. Examples of the wireless charging method are magnetic resonance charging, magnetic induction charging, and electromagnetic charging. To this end, the PMIC may further include an additional circuit for wireless charging, such as a coil loop, a resonance circuit, a rectifier, etc. The battery gauge is capable of measuring the residual capacity, charge in voltage, current, or temperature of the battery 296.

The battery 296 may take the form of either a rechargeable battery or a solar battery. The indicator 297 is capable of displaying a specific status of the electronic device 201 or a part thereof (e.g., the processor 210), e.g., a boot-up status, a message status, a charging status, etc. The motor 298 is capable of converting an electrical signal into mechanical vibrations, such as, a vibration effect, a haptic effect, etc. The electronic device 201 may also include a processing unit (e.g., GPU) for supporting a mobile TV. The processing unit for supporting a mobile TV is capable of processing media data pursuant to standards, e.g., digital multimedia broadcasting (DMB), digital video broadcasting (DVB), or mediaFlo™, etc.

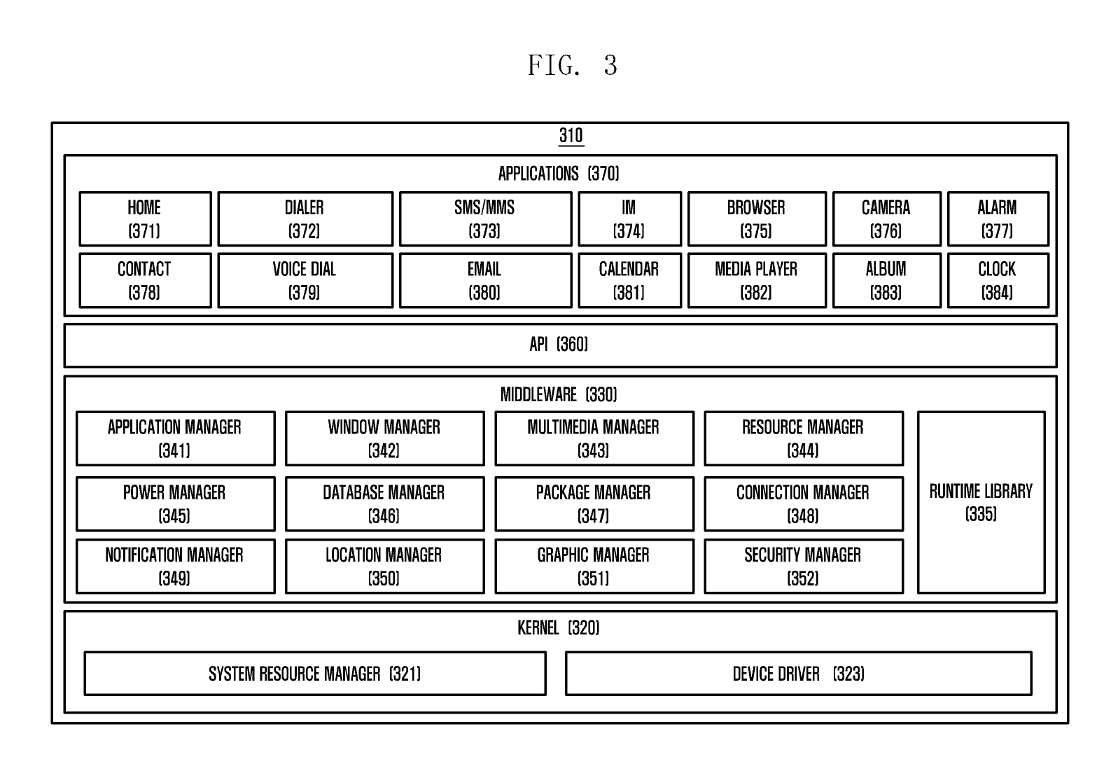

FIG. 3 is a block diagram of a programming module according to an embodiment of the present disclosure.

Referring to FIG. 3, a program module 310 (e.g., program module 140 shown in FIG. 1) is capable of including an OS for controlling resources related to the electronic device (e.g., electronic device 101) and/or various applications (e.g., application programs 147 shown in FIG. 1) running on the OS. The OS may be Android, iOS, Windows, Symbian, Tizen, Bada, etc.

The program module 310 is capable of including a kernel 320, middleware 330, an API 360 and/or applications 370. At least part of the program module 310 may be preloaded on the electronic device or downloaded from a server (e.g., an electronic device 102 or 104, server 106, etc.).

The kernel 320 (e.g., kernel 141) may include a system resource manager 321 and/or a device driver 323. The system resource manager 321 may include, for example, a process manager, a memory manager, and a file system manager. The system resource manager 321 may perform a system resource control, allocation, and recall. The device driver 323 may include, for example, a display driver, a camera driver, a Bluetooth driver, a shared memory driver, a USB driver, a keypad driver, a Wi-Fi driver, and an audio driver. Further, according to an embodiment, the device driver 323 may include an Inter-Process Communication (IPC) driver.

The middleware 330 may provide a function required in common by the applications 370. Further, the middleware 330 may provide a function through the API 360 to allow the applications 370 to efficiently use limited system resources within the electronic device. According to an embodiment, the middleware 330 (e.g., the middleware 143) may include at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, and a security manager 352. Furthermore, although not shown, the middleware 330 may also include a payment manager.

The runtime library 335 may include, for example, a library module used by a complier to add a new function through a programming language while the applications 370 are executed. According to an embodiment, the runtime library 335 executes input and output, management of a memory, a function associated with an arithmetic function and the like.

The application manager 341 may manage, for example, a life cycle of at least one of the applications 370. The window manager 342 may manage GUI resources used on the screen. The multimedia manager 343 may detect a format required for reproducing various media files and perform an encoding or a decoding of a media file by using a codec suitable for the corresponding format. The resource manager 344 manages resources such as a source code, a memory, or a storage space of at least one of the applications 370.

The power manager 345 may operate together with a basic input/output system (BIOS) to manage a battery or power and provides power information required for the operation. The database manager 346 may manage generation, search, and change of a database to be used by at least one of the applications 370. The package manager 347 may manage an installation or an update of an application distributed in a form of a package file.

The connection manager 348 may manage, for example, a wireless connection such as Wi-Fi or Bluetooth. The notification manager 349 may display or notify a user of an event such as an arrival of a message, an appointment, a proximity alarm, or the like, in a manner that does not disturb the user. The location manager 350 may manage location information of the electronic device. The graphic manager 351 may manage a graphic effect provided to the user or a user interface related to the graphic effect. The security manager 352 provides a general security function required for a system security or a user authentication. According to an embodiment, when the electronic device (e.g., the electronic device 101) has a call function, the middleware 330 may further include a telephony manager for managing a voice of the electronic device or a video call function.

The middleware 330 is capable of including modules for configuring various combinations of functions of the above described components. The middleware 330 is capable of providing modules that are specialized according to the types of operating systems to provide distinct functions. The middleware 330 may be adaptively configured in such a way as to remove part of the existing components or to include new components.

The API 360 (e.g., API 145) may be a set of API programming functions and may be provided with a different configuration according to an operating system. For example, in Android or iOS, a single API set may be provided for each platform. In Tizen, two or more API sets may be provided.

The applications 370 (e.g., application programs 147) may include one or more applications for performing various functions, for example, home 371, dialer 372, short message service (SMS)/multi-media message service (MMS) 373, instant message (IM) 374, browser 375, camera 376, alarm 377, contact 378, voice dial 379, email 380, calendar 381, media player 382, album 383, and clock 384. Furthermore, although not shown, the applications 370 may also include health care (e.g., an application for measuring amount of exercise, blood sugar level, etc.), and environment information (e.g., an application for providing atmospheric pressure, humidity, temperature, etc.).

According to an embodiment, the applications 370 are capable of including an application for supporting information exchange between an electronic device (e.g., electronic device 101) and an external device (e.g., electronic devices 102 and 104), which is hereafter called ‘information exchange application’. The information exchange application is capable of including a notification relay application for relaying specific information to external devices or a device management application for managing external devices.

According to an embodiment, the applications 370 are capable of including an application (e.g., a health care application of a mobile medical device, etc.) having specified attributes of an external device (e.g., electronic devices 102 and 104). According to an embodiment, the applications 370 are capable of including applications received from an external device (e.g., a server 106, electronic devices 102 and 104). According to an embodiment, the applications 370 are capable of including a preloaded application or third-party applications that can be downloaded from a server. It should be understood that the components of the program module 310 may be called different names according to the type of operating systems.

The term “module” according to the embodiments of the disclosure, means, but is not limited to, a unit of one of software, hardware, and firmware, or any combination thereof. The term “module” may be used interchangeably with the terms “unit,” “logic,” “logical block,” “component,” or “circuit.” The term “module” may denote the smallest unit of a component or a part thereof. The term “module” may be the smallest unit for performing at least one function or a part thereof. A module may be implemented mechanically or electronically. For example, a module may include at least one of an application-specific integrated circuit (ASIC) chip, field-programmable gate arrays (FPGAs), and a Programmable-Logic Device known or to be developed for certain operations.

According to various embodiments of the present disclosure, the devices (e.g. modules or their functions) or methods may be implemented by computer program instructions stored in a non-transitory computer-readable storage medium. In the case that the instructions are executed by at least one processor (e.g. processor 120), the at least one processor may execute the functions corresponding to the instructions. The computer-readable storage medium may be the non-transitory memory 130. At least a part of the programing module may be implemented (e.g. executed) by the processor 120. At least a part of the programing module may include modules, programs, routines, sets of instructions, and processes for executing the at least one function.

The non-transitory computer-readable storage medium includes magnetic media such as a floppy disk and a magnetic tape, optical media including a compact disc (CD) ROM and a DVD ROM, a magneto-optical media such as a floptical disk, and the hardware device designed for storing and executing program commands such as ROM, RAM, and flash memory. The program commands include the language code executable by computers using the interpreter, as well as the machine language codes created by a compiler. The aforementioned hardware device can be implemented with one or more software modules for executing the operations of the various embodiments of the present disclosure.

The module or programming module of the present disclosure may include at least one of the aforementioned components with the omission of some components or addition of other components. The operations of the modules, programming modules, or other components may be executed in series, in parallel, recursively, or heuristically. Also, some operations may be executed in a different order, omitted, or extended with other operations.

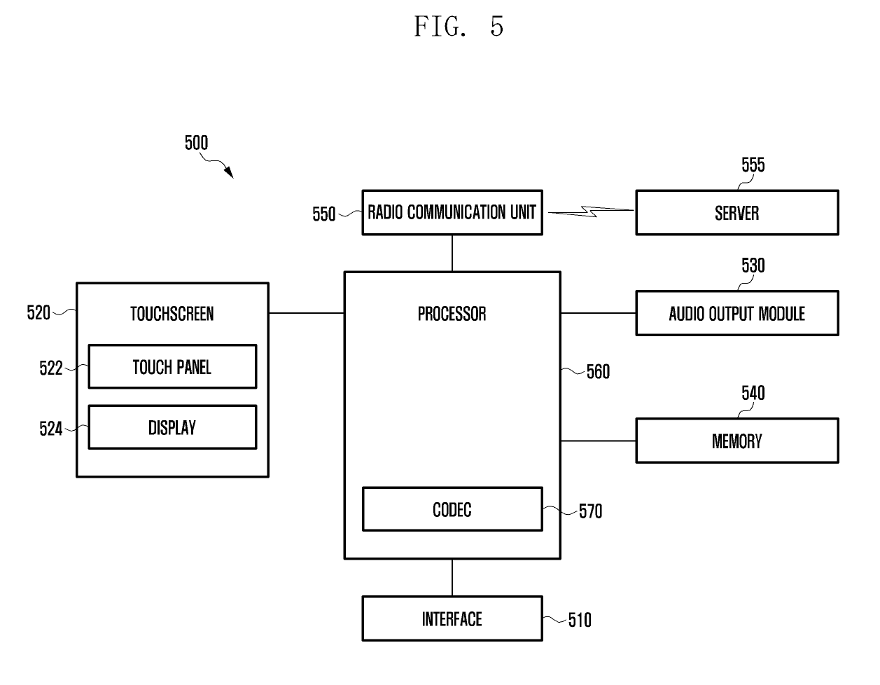

In addition, it would be recognized that when a general-purpose computer (e.g., electronic device 201 of FIG. 2 and electronic device 500 of FIG. 5) accesses code for implementing the processing described in this disclosure, the execution of the code transforms the general-purpose computer into a special purpose computer for executing the processing described in this disclosure. In addition, an artisan understands and appreciates that a “processor”, “microprocessor”, “application processor”, etc., constitute hardware in the claimed disclosure that contain circuitry that is configured for operation. Under the broadest reasonable interpretation, the appended claims constitute statutory subject matter in compliance with 35 U.S.C. § 101.

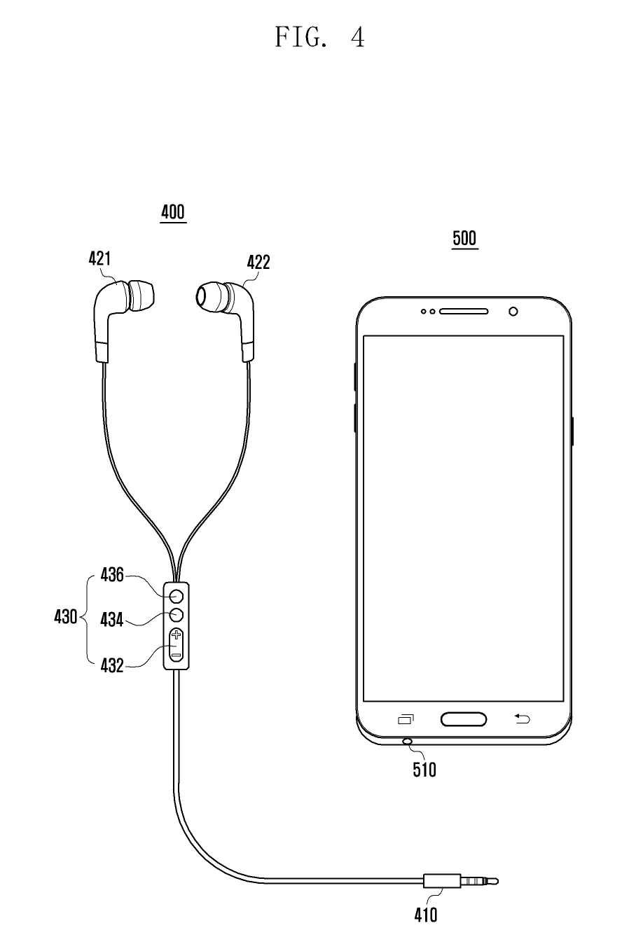

FIG. 4 is a schematic diagram illustrating one possible configuration of an earphone and an electronic device according to an embodiment of the present disclosure.

With reference to FIG. 4, the earphone 400 may include an earphone connector 410, a first audio output module 421, a second audio output module 422, and an earphone controller 430 according to various embodiments of the present disclosure.

According to various embodiments of the present disclosure, the earphone 400 may be detachably connected to the electronic device 500 (e.g., electronic device 101 of FIG. 1 and electronic device 201 of FIG. 2). The earphone 400 may be identical with the earphone 286 of FIG. 2.

The earphone connector 410 may be detachably connected to the electronic device 500 via an interface 510. The earphone connector 410 may be an earphone plug that is inserted into a plug hole of the interface 510 of the electronic device 500. The interface 510 of the electronic device 500 may be an ear jack for receiving the earphone connector 410. The interface 510 may have a plug hole for receiving the earphone connector 410. The earphone connector 410 may include 3 or 4 poles depending on the design of the earphone 400. In the case that the earphone connector 410 has 3 poles, the poles may correspond to a left terminal (L), a right terminal (R), and a ground terminal(G), respectively. In the case that the earphone connector has 4 poles, the poles may correspond to a left terminal (L), a right terminal (R), a ground terminal (G), and a microphone terminal (M).

The first and second audio output modules 421 and 422 are connected to the earphone connector 410 through a cord that is separated at a predetermined point. The first audio output module 421 may output an audio signal to the left ear of the user of the electronic device 500. The second audio output module 422 may output an audio signal to the right ear of the user of the electronic device 500. In the case that the electronic device 500 outputs stereo type audio signals, the first and second audio output modules 421 and 422 may output left and right channel audio signals, respectively. In the case that the electronic device 500 outputs mono type audio signals, the first and second audio output modules 421 and 422 may output the audio signals without distinction between left and right channels.

According to various embodiments of the present disclosure, the earphone 400 may allow setting the impedances of its first and second audio output modules 421 and 422 to different values. The first audio output module 421 may have a first impedance value (e.g., 27 Ω˜37 Ω). The second audio output module 422 may have a second impedance value (e.g., 42 Ω˜52 Ω).

The earphone controller 430 may be arranged between the earphone connector 410 and the first and second audio output modules 421 and 422.

According to an embodiment of the present disclosure, the earphone controller 430 may include a volume adjustment button 432, a microphone button 434, and a function input button 436.

In response to an input made by the volume adjustment button 432, the electronic device 500 may adjust (+, −) the volume of the audio signals to be output through the first and second audio output modules 421 and 422.

In response to an input made with the microphone button 434, the electronic device 500 may enter a call mode in which the audio signal output to the earphone 400 is blocked, such that the first and second audio output modules 421 and 422 of the earphone 400 and the microphone are configured for a voice call conversation between the user of electronic device 500 and the user of another electronic device.

In response to the input made with the function input button 436, the electronic device 500 may execute a designated function. According to an embodiment of the present disclosure and, depending on the type of the earphone 400 (e.g., type A, type B, and type C), the electronic device 500 may execute a different function in response to the input made with the function input button 436. For example, if the earphone 400 is a type A earphone, the electronic device 500 may execute a music player in response to the input made with the function input button 436. If the earphone 400 is a type B earphone, the electronic device 500 may execute a recorder in response to the input made with the function input button 436. According to an embodiment of the present disclosure, the function input button 436 may be optionally provided, and the corresponding function may be executed by another input button (e.g., microphone button 443). That is, in the case where the function input button 436 is omitted, the electronic device 500 may execute a function of the electronic device in response to the input made with the microphone button 434, where the type of function executed depends on the type of the earphone 400.

FIG. 5 is a block diagram illustrating one possible configuration of an electronic device according to various embodiments of the present disclosure.

With reference to FIG. 5, the electronic device 500 according to the various embodiments of the present disclosure may include an interface 510, a touchscreen 520, an audio output module 530, a non-transitory memory 540, a radio communication unit 550, and a processor 560.

The electronic device 500 may include parts of or all of the components of electronic devices 101, 102, and 104 of FIG. 1 and the electronic device 201 of FIG. 2. Examples of the electronic device 500 may include at least one of a smartphone, a tablet device, and a wearable device. The interface 510 may include at least part of the interface 270 of FIG. 2. The audio output module 530 may include the audio module 280 of FIG. 2. The non-transitory memory 540 may include the non-transitory memory 130 of FIG. 1 or the non-transitory memory 230 of FIG. 2. The radio communication unit 550 may include the communication interface 170 of FIG. 1 or the communication module 220 of FIG. 2. The processor 460 may include the processor 120 of FIG. 1 and the processor 210 of FIG. 2.

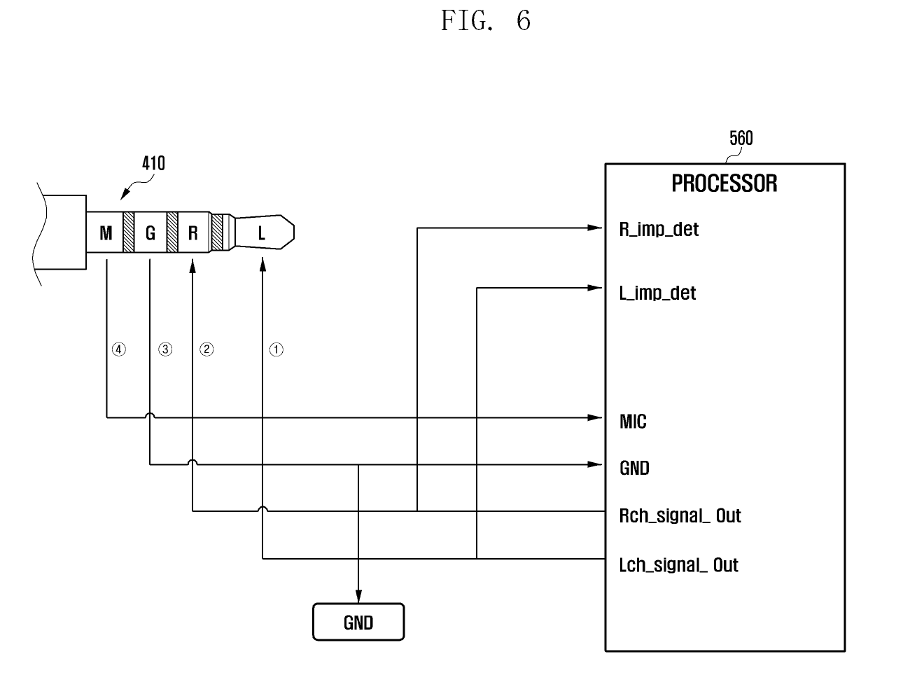

If the earphone connector 410 of the earphone 400 is inserted into the plug hole of the interface 510, the interface 510 may detect the insertion of the earphone connector 410. The interface 510 may have terminals formed on the surface of its plug hole for contacting the corresponding poles of the earphone connector 410. For example, with reference to FIG. 6, in the case that the earphone connector 410 has 4 poles, the interface 510 may include four terminals for contacting the left channel pole L, the right channel pole R, the group pole G, and the microphone pole M, respectively, as denoted by reference numbers \textcircled{1}, \textcircled{2}, \textcircled{3}, and \textcircled{4}.

If the electronic device 500 recognizes the type of the earphone based on the first impedance value (e.g., 27 Ω˜37 Ω) of the first audio output module 421 and the second impedance value (e.g., 42 Ω˜52 Ω) of the second audio output module 422 of the earphone 400, the touchscreen 520 may display a user interface (UI) that presents the type of the earphone. The touchscreen 520 may also display a UI for adjusting audio output in dependence on the type of the earphone.

According to various embodiments of the present disclosure, the touchscreen 520 may have an input function and a display function. For this purpose, the touchscreen 520 may include a touch panel 522 (e.g., touch panel 252 of FIG. 2) and the display 524 (e.g., display 160 of FIG. 1 and display 260 of FIG. 2). The touch panel 522 may detect a touch input made by the user and generate and send a detection signal to the processor 560. For example, if a touch is made by the user for adjusting audio output in an earphone type-specific manner, the touch panel 522 may generate a signal (e.g., equalization (EQ) signal) for adjusting the audio level and the frequency that is appropriate for the characteristic of the audio and send the signal to the processor 560. The display 524 may be implemented with a liquid crystal display (LCD), an organic light emitting diodes (OLED), or an active matrix OLED (AMOLED) to provide the user with menus of the electronic device 500, input data, function setting information, and other information. According to various embodiments of the present disclosure, if the electronic device 500 recognizes the type of the connected earphone, the display 524 displays a UI that presents detailed information about the recognized type of earphone, as well as other information such as residual battery capacity.

If the electronic device 500 recognizes the type of connected earphone based on the first impedance value (e.g., 27 Ω˜37 Ω) of the first audio output module 421 and the second impedance value (e.g., 42 Ω˜52 Ω) of the second audio output module 422 of the earphone 400, the audio output module 530 may output a voice notification for notifying the user of the recognized earphone type (e.g., “earphone optimized for music listening is detected” and “earphone optimized for gaming is detected”).

The non-transitory memory 540 may store various UIs or voice notifications for making a notification to the user or allowing the user to adjust audio output when the electronic device 500 recognizes the type of connected earphone. The memory 540 may store a program for controlling the audio output in dependence on the type, characteristics, and functions of the earphone based on the first impedance value (e.g., 27 Ω˜37 Ω) of the first audio output module 421 and the second impedance value (e.g., 42 Ω˜52 Ω) of the second audio output module 422 of the earphone 400. The program for controlling the audio output may include a routine for detecting a connection of an earphone, a routine for detecting the type of the connected earphone, and a table.

For example, the non-transitory memory 540 may store a Table 1. Table 1 may include information that is specific to each type of earphone, such as first impedance values of the first audio output module 421, second impedance values of the second audio output module 422, the difference between the first and second impedance values, characteristics of the earphone, and the earphone type.

TABLE 1

| | First | | | |
|---|---|---|---|---|
| | impedance | Second | Impedance | Characteristic |
| Type | value | impedance value | difference | (function) |
| A | 32 Ω | 47 Ω | 15 Ω | Bass enhancement |
| B | 32 Ω | 32 Ω | 0 | Equal |
| C | 16 Ω | 24 Ω | 8 Ω | Treble enhancement |

As shown in Table 1, the table stored in the non-transitory memory 540 may be called by the processor 560 for executing earphone type-specific functions upon connecting the earphone connector 410 of the earphone 400 to the interface 510 of the electronic device 500.

According to various embodiments of the present disclosure, the non-transitory memory 540 may store programs for process and control of the processor 560, an operating system (OS), applications, input/output data, and programs for controlling overall operations of the electronic device 500. The memory 540 may also store various settings information necessary for executing the functions of the electronic device 500. The memory 540 may also store video files, game files, music files, and movie files.

If there is a failure to retrieve an earphone that matches the type and function of the connected earphone from the table stored in the memory 540, the radio communication unit 550 may communicate to a server 555 the first and second impedance values, the difference between the first and second impedance values, and the characteristics of the corresponding earphone.

According to various embodiments of the present disclosure, the radio communication unit 550 may include a cellular module for supporting cellular communication (e.g., 2^{nd} generation (2G), 3^{rd} generation (3G), 4th generation (4G), and 5th generation (5G) communication) and a short range wireless communication module for supporting short range wireless communication (e.g., wireless local area network (WLAN) communication, wireless fidelity (Wi-Fi) communication, Bluetooth communication, infrared communication, and Zigbee). The radio communication unit 550 may include a radio frequency (RF) transmitter for performing frequency up-conversion and amplification on a transmit signal and an RF receiver for performing low noise amplification and down-conversion on a receive signal. The radio communication unit 550 may deliver data received from the server 555 to the processor 560 and transmit the data output from the processor 560 to the server 555 over a radio channel.

The server 555 may communicate with the radio communication unit 550 of the electronic device 500 in order for the electronic device 500 to update the memory 540 in real time with information that is specific to the earphone that has no match in the memory 540. This information received from server 555 can be, for example, first impedance values, second impedance values, the difference between the first and second impedance values, and characteristics of the earphone. The server 555 may be identical with the server 106 of FIG. 1.

According to an embodiment of the present disclosure, the user of the server 555 may measure the first impedance value of the first audio output module 421 and the second impedance value of the second audio output module 422 of the earphone 400. If the server 555 fails to retrieve information that matches the measured first and second impedance values, the server 555 may register the corresponding earphone with the table and may further designate and execute functions of the corresponding earphone. The processor 560 may control the functions and operations of the interface 510, touchscreen 520, audio output module 530, non-transitory memory 540, and radio communication unit 550 of the electronic device 500. The processor 560 may detect the connection of the earphone 400, including the first audio output module 421 with the first impedance value (e.g., 27 Ω˜37 Ω) and the second audio output module 422 with the second impedance value (e.g., 42 Ω˜52 Ω). The processor 560 may adjust the audio in dependence on the characteristic of the detected earphone and output the adjusted audio.

According to an embodiment of the present disclosure, the processor 560 may include a codec 570. The codec 570 may include an analog to digital (AD) or digital to analog (DA) converter. If the earphone connector 410 is connected to the electronic device 500 through the interface 510, the codec 570 may detect the first impedance value of the first audio output module 421 and the second impedance value of the second audio output module 422 of the earphone 400. The codec 570 may output various audio signals generated by the electronic device 500.

According to an embodiment of the present disclosure, the processor 560 may detect an input (e.g., connection) of the earphone 400 (or earphone connector 410) by means of the interface 510. The processor 560 may check (e.g., detect) the first impedance value of the first audio output module 421 and the second impedance value of the second audio output module 422 of the earphone 400. The processor 560 may be configured to determine the type (e.g., type A, type B, type C, etc.) of the earphone 400 based on at least one of the first and second impedance values. The processor 560 may be configured to adjust the characteristics (e.g., sound level and frequency) related to the audio output of the electronic device 500 based on at least the identified type of earphone.

According to an embodiment of the present disclosure, the processor 560 may check the difference between the first impedance value of the first audio output module 421 and the second impedance value of the second audio output module 422. The processor 560 may identify the first type (e.g., type A in Table 1) as the type of earphone for the case where the difference between the first and second impedance values falls within a first range (e.g., 10 Ω˜25 Ω) and the second type (e.g., type C in Table 1) as the type of earphone for the case where the difference between the first and second impedance values falls within a second range (e.g., out of the range of 10 Ω˜25 Ω).

According to an embodiment of the present disclosure, the processor 560 may execute a first function (e.g., bass enhancement) for the case where earphone 400 is identified as the first type (e.g., Type A in Table 1), and a second function (e.g., treble enhancement) for the case where earphone 400 is identified as the second type (e.g., Type C in Table 1), in response to an input made by means of the function input button 436 of the earphone controller 430 of the earphone 400.

According to an embodiment of the present disclosure, the processor 560 may be configured to execute the first function (e.g., bass enhancement) for the case where earphone 400 is identified as the first type and the second function (e.g., treble enhancement) for the case where earphone 400 is identified as the second type.

According to an embodiment of the present disclosure, the processor 560 may be configured to control the touchscreen 520 to display a UI that presents the identified type of the earphone 400.

According to an embodiment of the present disclosure, the processor 560 may be configured to control the audio output module 530 to output a voice notification that identifies the type of earphone 400.

According to an embodiment of the present disclosure, the processor 560 may be configured to control the touchscreen 520 to display a UI for adjusting the audio characteristic in dependence on the identified type of earphone 400.

According to an embodiment of the present disclosure, if the type of earphone 400 cannot be retrieved from the non-transitory memory 540, the processor 560 may be configured to receive information from an external electronic device. The information can be used to identify the type of earphone that cannot be initially retrieved from the memory 540. The memory 540 can be updated with the received information for use in identifying the type of the earphone.

According to an embodiment of the present disclosure, the processor 560 may be configured to control the touchscreen 520 to display, if the identified type of the earphone 400 is not retrieved from the non-transitory memory 540, a UI for use in storing at least part of the information that is necessary for identifying the type of the earphone 400.

According to various embodiments of the present disclosure, the processor 560 may adjust audio parameters related to audio communication with the earphone 400. The audio parameters may include a few non-limiting possibilities, such as receiving loudness rating (RLR), receiving frequency response (RFL), sending loudness rating (SLR), noise suppression (N/S) solution, gain, equalizer (EQ), base enhancer, and reverberation.

According to various embodiments of the present disclosure, the processor 560 may control the overall operations and signal flows among the internal components of the electronic device 500, as well as process data. The processor 560 may include a central processing unit (CPU), an application processor, and a communication processor. The processor 560 may be implemented as a single-core processor or a multi-core processor or include multiple processors.

According to various embodiments of the present disclosure, and in response to an input made by means of the function input button 436 of the earphone 400, the processor 560 may execute application A (e.g., music player) for the case where the identified type of the earphone 400 is Type A and may execute application B (e.g., recorder) for the case where the identified type of the earphone 400 is Type B.

FIG. 6 is a diagram illustrating a possible connection relationship between an earphone and an electronic device according to various embodiments of the present disclosure.

With reference to FIG. 6, the earphone connector 410 may include a left channel pole L, a right channel pole R, a ground pole (G), and a microphone pole M. The interface 510 of the electronic device 500 may include four terminals that correspond respectively to the left channel pole L, the right channel pole R, the group pole G, and the microphone pole M as denoted by reference numbers \textcircled{1}, \textcircled{2}, \textcircled{3}, and \textcircled{4}.

The third terminal of the interface 510 may be connected to a ground (GND) port of the processor 560 (or codec 570) as denoted by reference number 3. The fourth terminal may be connected to a microphone (MIC) port of the processor 560 (or codec 570) as denoted by reference number D.

The processor 560 (or codec 570) may output an impedance detection signal to the left channel pole L of the earphone connector 410 through a first signal output port (Lch_signal_Out) and detect the first impedance value of the first audio output module 421 from the left channel pole L through the first detection port (L_imp_detect). The processor 560 (or codec 570) may output an impedance detection signal to the right channel pole R of the earphone connector 410 through a second signal output port (Rch_signal_Out) and detect the second impedance value of the second audio output module 422 from the right channel pole R through a second detection port (R_imp_det). The processor 560 may detect the first impedance value of the first audio output module 421 and the second impedance value of the second audio output module 422 in other manners (e.g., using the AD convertor).

According to various embodiments of the present disclosure, a non-transitory computer-readable recording medium storing a program for controlling functions of the electronic device 500 for executing a method including an operation of detecting an input of the earphone 400 having the first audio output module 421 with a first impedance value and the second audio output module 422 with a second impedance value through the interface 510, an operation of checking the first impedance value of the first audio output module 421 and the second impedance value of the second audio output module 422, an operation of identifying the type of the earphone 400 based on at least the first and second impedance values, and an operation of adjusting a characteristic related to audio output of the electronic device 500 based on at least the identified type of the earphone 400.

According to an embodiment of the present disclosure, the operation of identifying the type of the earphone 400 may include an operation of checking the difference between the first and second impedance values; identifying, whether the difference falls within a first range and, if it does, then earphone 400 corresponds to an earphone of the first type; and identifying, whether the difference falls within a second range and, if it does, then earphone 400 corresponds to an earphone of the second type.

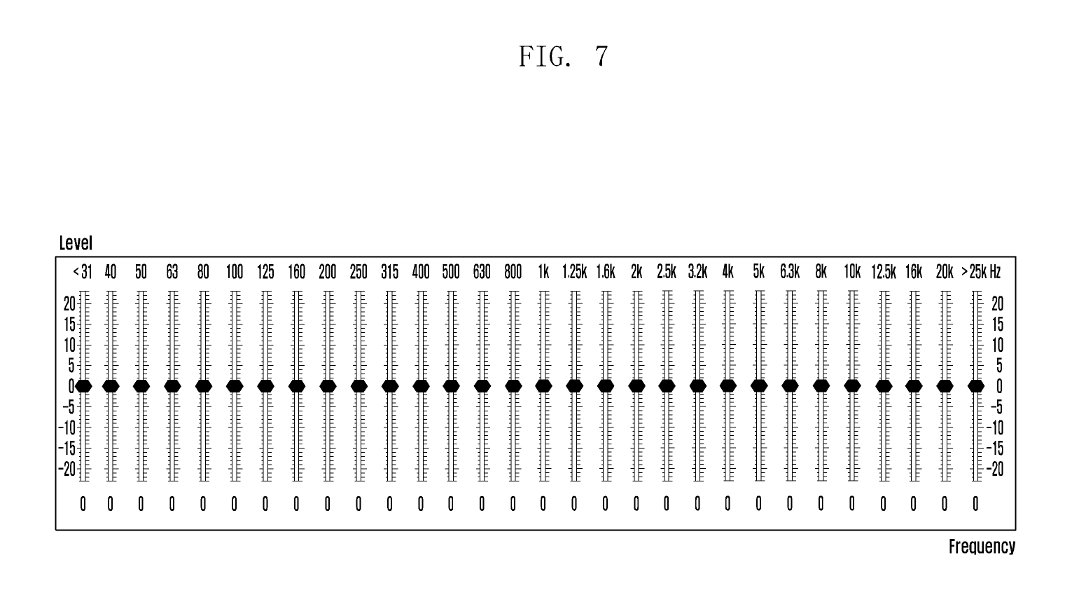

FIG. 7 is a diagram illustrating a possible audio output characteristic when impedance values of the first and second audio output modules of an earphone are identical to each other according to various embodiments of the present disclosure.

With reference to FIG. 7, the processor 560 may identify earphone 400 as being the second type (e.g., Type B) of earphone by referencing the table (e.g., Table 1) stored in the non-transitory memory 540 if the first impedance value (e.g., about 32 Ω) of the first audio output module 421 and the second impedance value (e.g., about 32 Ω) of the second audio output module 422 of the earphone 400 are identical to each other. In this case, the processor 560 may output the audio signal without adjusting the output characteristic of the audio (e.g., sound level and frequency).

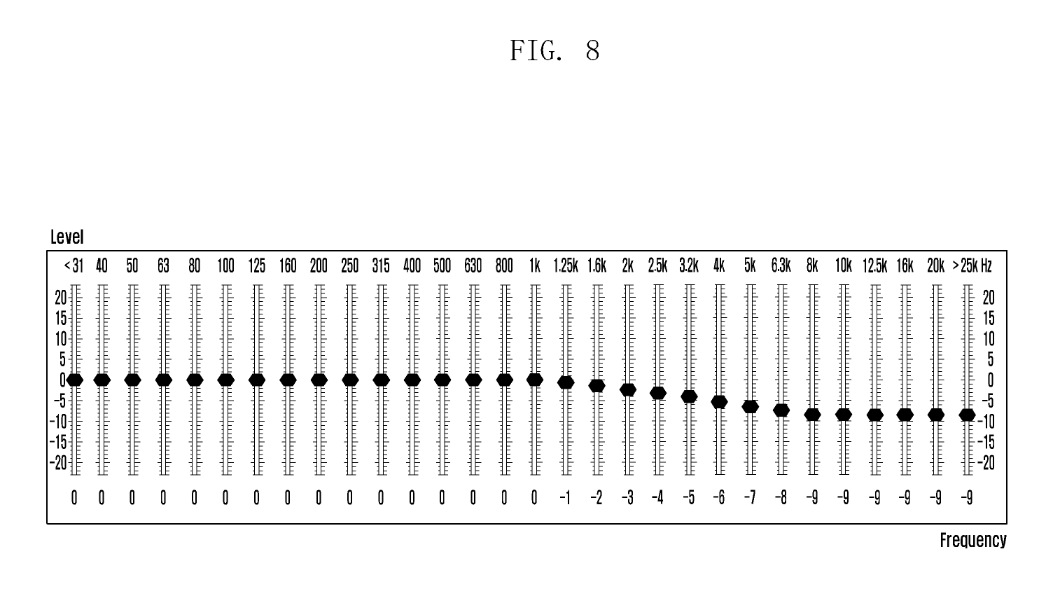

FIG. 8 is a diagram illustrating a possible audio output characteristic when a difference between the impedance values of the first and second audio output modules of an earphone falls within a first range (e.g., 10 Ω˜25 Ω) according to various embodiments of the present disclosure.

With reference to FIG. 8, the processor 560 may identify earphone 400 as being the first type (e.g. Type A) of earphone by referencing the table (e.g., Table 1) stored in the non-transitory memory 540 if the first impedance value (e.g., about 32 Ω) of the first audio output module 421 and the second impedance value (e.g., about 47 Ω) of the second audio output module 422 of the earphone 400 are different from each other. In this case, the processor 560 may check the difference between the first impedance value (e.g., about 32 Ω) of the first audio output module 421 and the second impedance value (e.g., about 47 Ω) of the second audio output module 422 and identify the range into which the difference of the impedance values falls. For example, the processor 560 may be configured to execute a first function if the difference between the first impedance value (e.g., about 32 Ω) and the second impedance value (e.g., about 47 Ω) falls into a first range (e.g., 10 Ω˜25 Ω). For example, the first function may adjust the output characteristic of the audio (e.g., sound level and frequency) to output bass-enhanced audio.

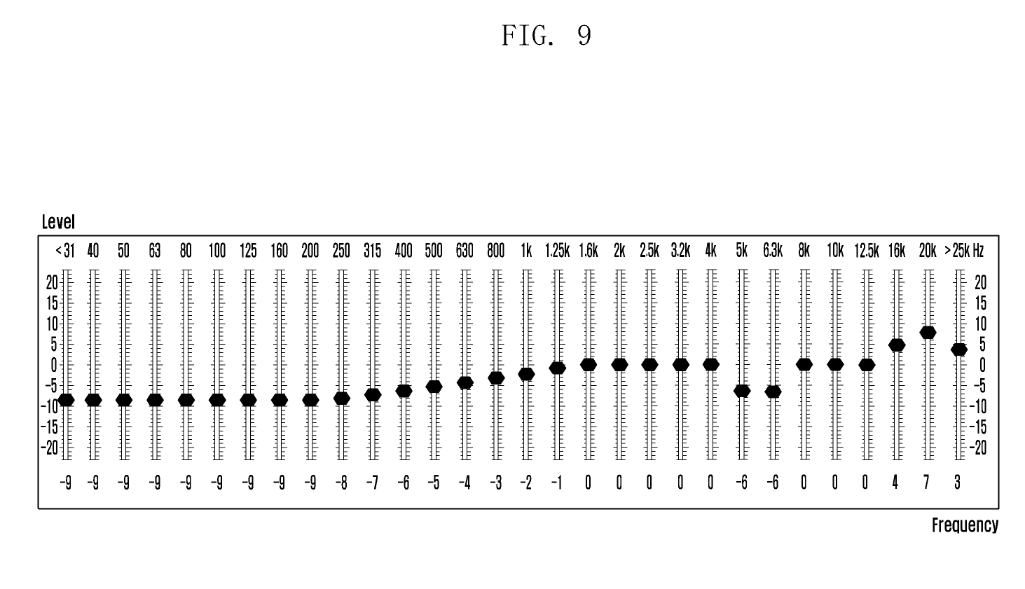

FIG. 9 is a diagram illustrating an audio output characteristic when a difference between the impedance values of the first and second audio output modules of an earphone falls within a second range (e.g., out of 10 Ω˜25 Ω) according to various embodiments of the present disclosure.

With reference to FIG. 9, the processor 560 may identify earphone 400 as being the second type (e.g. Type C) of earphone by referencing the table (e.g., Table 1) stored in the non-transitory memory 540 if the first impedance value (e.g., about 16 Ω) of the first audio output module 421 and the second impedance value (e.g., about 24 Ω) of the second audio output module 422 of the earphone 400 are different from each other. In this case, the processor 560 may check the difference (e.g., 8 Ω) between the first impedance value (e.g., about 16 Ω) of the first audio output module 421 and the second impedance value (e.g., about 24 Ω) of the second audio output module 422 and identify the range into which the difference of the impedance values falls. For example, the processor 560 may be configured to execute a second function if the difference between the first impedance value (e.g., about 16 Ω) and the second impedance value (e.g., about 24 Ω) falls into a second range (e.g., about 8 Ω). For example, the second function may adjust the output characteristic of the audio (e.g., sound level and frequency) to output treble-enhanced audio.

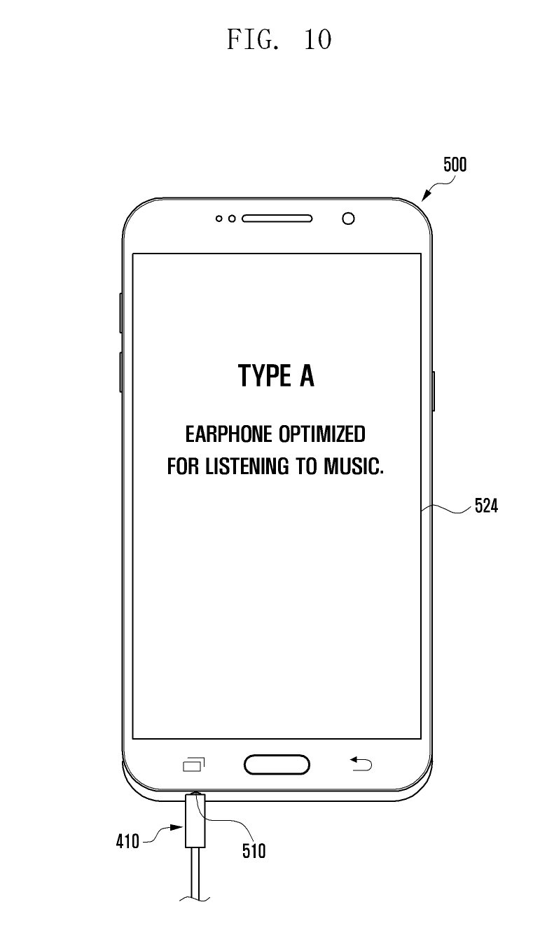

FIG. 10 is a diagram illustrating an exemplary screen display presenting a type of an earphone connected to an electronic device according to various embodiments of the present disclosure.

With reference to FIG. 10, if the earphone connector 410 is connected to the electronic device 500 through the interface 510, the processor 560 may detect the first impedance value (e.g., 27 Ω˜37 Ω) of the first audio output module 421 and the second impedance value (e.g., 42 Ω˜52 Ω) of the second audio output module 422 of the earphone 400. The processor 560 may identify the type of the connected earphone based on the first impedance value (e.g., 27 Ω˜37 Ω) and the second impedance value (e.g., 42 Ω˜52 Ω). The processor 560 may control the display 524 to display a UI with information on the type of the connected earphone. For example, the processor 560 may control the display 524 to display the UI with a text message saying, “Type A, earphone optimized for listening to music.” The processor 560 may also control the audio output module 530 to output a voice notification message saying, “Type A, earphone optimized for listening to music.”

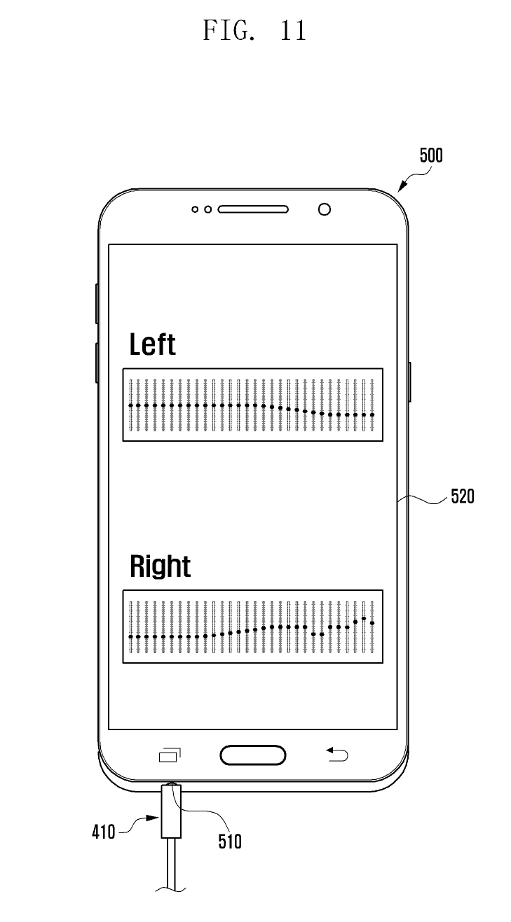

FIG. 11 is a diagram illustrating an exemplary screen display during the adjustment of audio output in dependence on the type of earphone connected to the electronic device according to various embodiments of the present disclosure.

With reference to FIG. 11, if the earphone connector 410 is connected to the electronic device 500 through the interface 510, the processor 560 may detect the first impedance value (e.g., 27 Ω˜37 Ω) of the first audio output module 421 and the second impedance value (e.g., 42 Ω˜52 Ω) of the second audio output module 422 of the earphone 400. The processor 560 may identify the type of the connected earphone based on the first impedance value (e.g., 27 Ω˜37 Ω) and the second impedance value (e.g., 42 Ω˜52 Ω). The processor 560 may control the touchscreen 520 to display a UI related to an audio characteristic adjustment in dependence on the type of the connected earphone. For example, the processor 560 may control the touchscreen 520 to display a UI related to the left and right audio output characteristics (e.g., sound level and frequency) of the earphone. The displayed UI enables the user to, for example, adjust the left and right audio outputs.

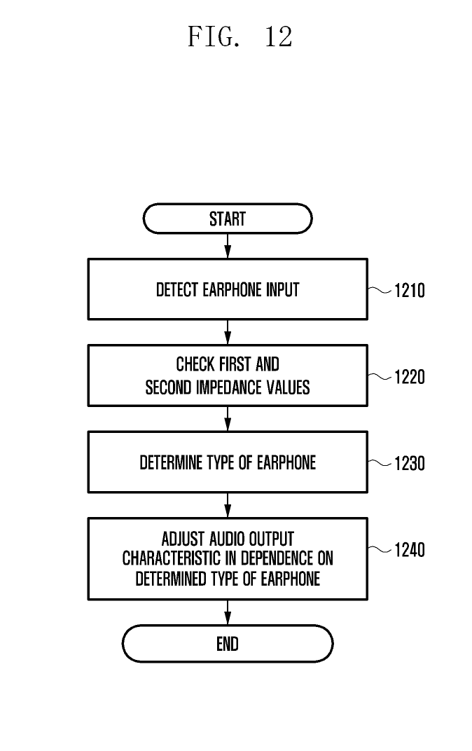

FIG. 12 is a flowchart illustrating an exemplary method for controlling audio output characteristics in dependence on the type of an earphone connected to an electronic device according to various embodiments of the present disclosure.

At step 1210, the processor 560 may detect an input (e.g., connection) of an earphone 400 (or earphone connector 410) through the interface 510.

At step 1220, the processor 560 may check (e.g., detect) the first impedance value of the first audio output module 421 and the second impedance value of the second audio output module 422 of the earphone 400.

At step 1230, the processor 560 may determine the type (e.g., Type A, Type B, or Type C) of the earphone 400 based on at least the first impedance value of the first audio output module 421 and the second impedance value of the second audio output module 422.

At step 1240, the processor 560 may adjust the audio output characteristics (e.g., sound level and frequency) based on at least the determined type of the earphone 400.

According to an embodiment of the present disclosure, the operation of determining the type of the earphone 400 may include an operation of checking a difference between the first and second impedance values by the processor 560; an operation of identifying, whether the difference falls into a first range and, if it does, then earphone 400 corresponds to an earphone of the first type; and an operation of identifying, whether the difference falls into a second range and, if it does, then earphone 400 corresponds to an earphone of the second type.

According to an embodiment of the present disclosure, the processor 560 may be configured to perform an operation of executing, if the first type is identified as the type of the earphone 400, a first function; and, if the second type is identified as the type of the earphone 400, a second function, in response to an input made on an input button (e.g., function input button 436) of the earphone.

According to an embodiment of the present disclosure, the processor 560 may be configured to perform an operation of executing, if the first type is identified as the type of the earphone 400, a first function; and, if the second type is identified as the type of the earphone 400, a second function.

According to an embodiment of the present disclosure, the processor 560 may be configured to perform an operation of controlling the touchscreen 530 to display a UI with an indication of the identified type of the earphone 400.

According to an embodiment of the present disclosure, the processor 560 may be configured to perform an operation of controlling the audio output module 530 to output a voice notification that identifies the type of earphone 400.

According to an embodiment of the present disclosure, the processor 560 may be configured to perform an operation of controlling the touchscreen 520 to display a UI for adjusting audio characteristics in dependence on the identified type of the earphone 400.

According to an embodiment of the preset disclosure, the processor 560 may be configured to perform an operation of receiving, if the identified type of the earphone 400 is not stored in the non-transitory memory 540, information on the identified type of earphone from an external electronic device by means of a communication module (e.g., radio communication unit 550) and updating the information for use in identifying the type of the earphone 400 with the received information.

According to an embodiment of the present disclosure, the processor 560 may be configured to perform an operation of controlling, if the identified type of the earphone 400 is not stored in the memory 540, the touchscreen 520 to display a UI for storing the information for use in identifying the type of the earphone 400 in the non-transitory memory 540.

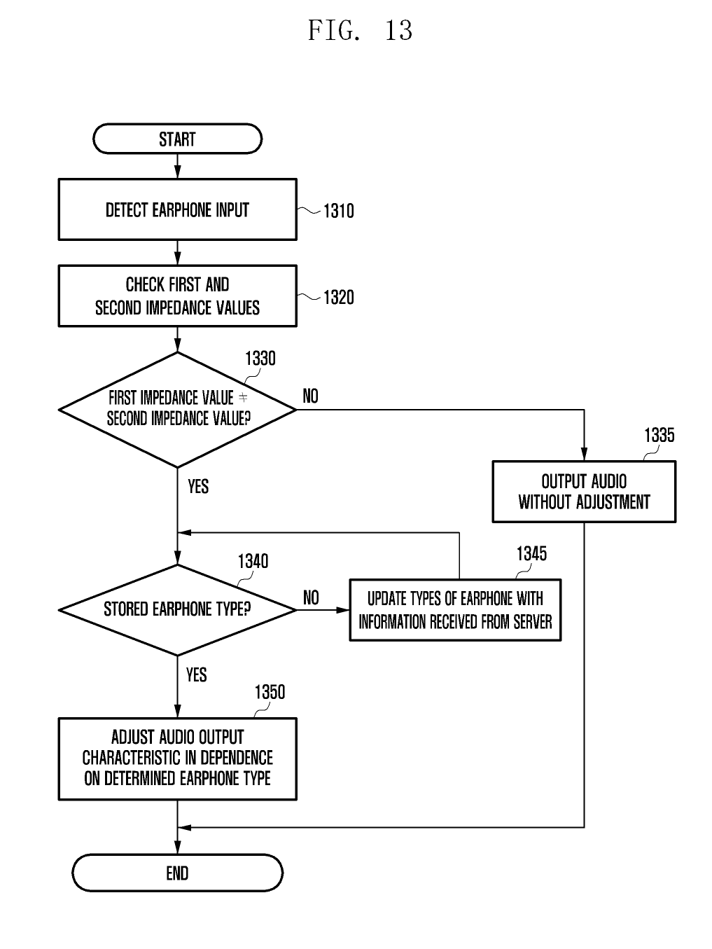

FIG. 13 is a flowchart illustrating another exemplary method for controlling audio output characteristics in dependence on the type of an earphone connected to the electronic device according to various embodiments of the present disclosure.

At step 1310, the processor 560 may detect an input (e.g., connection) of an earphone 400 (or earphone connector 410) through the interface 510.

At step 1320, the processor 560 may check (e.g., detect) the first impedance value of the first audio output module 421 and the second impedance value of the second audio output module 422 of the earphone 400.

At step 1330, the processor 560 may determine whether the first impedance value of the first audio output module 421 and the second impedance value of the second audio output module 422 differ from each other.

At step 1335, the processor may output, if the first and second impedance values are identical to each other, the audio signal with no adjustment of the output characteristic (e.g., sound level and frequency) of the audio as shown in FIG. 7.

At step 1340, the processor 560 may determine, if the first and second impedance values are different from each other, whether the earphone falls into one of the types stored in the non-transitory memory 540.

At step 1345, the processor 560 may receive, if the earphone does not fall into any of the earphone types stored in the non-transitory memory 540, information that corresponds to the type of earphone 400 from the server 555. For example, if the processor 560 detects that the earphone 400 is not one of the earphone types stored in the non-transitory memory 540, it may receive information on the first and second impedance values, the difference between the first and second impedance values, and characteristics corresponding to the type of earphone from the server 555 and update the memory 540 in real time.

At step 1350, the processor 560 may adjust, if the earphone 400 falls into one of the types stored in the memory 540, the audio output characteristics (e.g., sound level and frequency) in dependence on the type of the earphone as shown in FIGS. 8 and 9 to output a bass-enhanced and treble-enhanced audio.

As described above, the present disclosure is advantageous in terms of recognizing a predetermined type of earphone based on the impedances that are set to different values for a first audio output module (e.g., left) and a second audio output module (e.g., right) of the earphone and outputting audio that is optimized for the recognized type of earphone.

Although the present disclosure has been described with various embodiments, it is obvious to those skilled in the art that modifications and changes can be made thereto without departing from the spirit and scope of the present disclosure.

What is claimed is:

1. An electronic device comprising:
an interface configured to detect an input of an earphone having a first audio output module with a first impedance value and a second audio output module with a second impedance value; and
a processor configured to control the interface to detect the input of the earphone, check the first impedance value of the first audio output module and the second impedance value of the second output module, determine a type of the earphone based on at least the first and second impedance values, and adjust a characteristic related to audio output of the electronic device based on the determined type of earphone.

2. The electronic device of claim 1, wherein the processor is configured to check, as part of the determining step, a difference between the first and second impedance values and further identify whether the difference falls within a first range or a second range, and wherein the earphone corresponds to a first type or a second type of earphone when the difference falls within the first range or the second range, respectively.

3. The electronic device of claim 1, wherein the earphone further comprises an input button, and the processor is configured to execute, if the earphone is determined to correspond to a first type, a first function and, if the earphone is determined to correspond to a second type, a second function, in response to an input made with the input button.

4. The electronic device of claim 1, wherein the processor is configured to execute, if the earphone corresponds to a first type, a first function and, if the earphone corresponds to a second type, a second function.

5. The electronic device of claim 1, further comprising a touchscreen, wherein the processor is configured to control the touchscreen to display a user interface (UI) that presents the determined type of earphone.

6. The electronic device of claim 1, further comprising a third audio output module, wherein the processor is configured to control the third audio output module to output a voice notification for the determined type of earphone.

7. The electronic device of claim 1, wherein the processor is configured to provide a user interface (UI) on a touchscreen for adjusting an audio characteristic of the earphone in dependence on the determined type of earphone.

8. The electronic device of claim 1, further comprising:
a communication module; and
a memory configured to store information for identifying the type of the earphone,
wherein, if the determined type of earphone is not stored in the memory, the processor is configured to receive the information for identifying the type of the earphone from an external electronic device using the communication module and update the memory with the received information for identifying the type of the earphone.

9. The electronic device of claim 1, further comprising:
a touchscreen; and
a memory configured to store information for identifying the type of the earphone,
wherein, if the determined type of earphone is not stored in the memory, the processor is configured to control the touchscreen to display a user interface for storing at least part of the information for identifying the determined type of earphone.

10. A method comprising:
detecting, by a processor, via an interface of an electronic device, a first input of an earphone having a first audio output module with a first impedance value and a second audio output module with a second impedance value;
checking, by the processor, the first impedance value of the first audio output module and the second impedance value of the second output module;
determining, by the processor, a type of the earphone based on at least the first and second impedance values; and
adjusting, by the processor, a characteristic related to audio output of the electronic device based on the determined type of the earphone.

11. The method of claim 10, wherein the step of determining the type of the earphone comprises:
checking, by the processor, a difference between the first and second impedance values;
identifying, whether the difference falls within a first range, wherein the earphone corresponds to a first type when the difference falls within the first range; and
identifying, whether the difference falls into a second range, wherein the earphone corresponds to a second type when the difference falls within the second range.

12. The method of claim 10, further comprising:
executing, by the processor, if the earphone corresponds to a first type, a first function in response to a second input made with an input button; and
executing, by the processor, if the earphone corresponds to a second type, a second function in response to the second input made with the input button.

13. The method of claim 10, further comprising executing, by the processor, if the earphone corresponds to a first type, a first function and, if the earphone corresponds to a second type, a second function.

14. The method of claim 10, further comprising displaying, by the processor, a user interface (UI) on a touchscreen, wherein the UI presents the determined type of earphone.

15. The method of claim 10, further comprising outputting, by the processor, a voice notification for the determined type of earphone using a third audio output module.

16. The method of claim 10, further comprising providing a touchscreen with a user interface (UI) for adjusting an audio characteristic of the earphone in dependence on the determined type of earphone.

17. The method of claim 10, further comprising:
receiving, if the determined type of the earphone is not stored in a memory, information for identifying the type of the earphone from an external electronic device using a communication module; and
updating the memory with the received information for identifying the type of the earphone.

18. The method of claim 10, further comprising providing, if the determined type of earphone is not stored in a memory, a touchscreen with a user interface for storing information in the memory for identifying the determined type of earphone.

19. A non-transitory computer-readable recording medium for recording a program for performing a method of controlling audio output of an electronic device, the method comprising:
detecting, using an interface, an input of an earphone having a first audio output module with a first impedance value and a second audio output module with a second impedance value;
checking the first impedance value of the first audio output module and the second impedance value of the second output module;
determining a type of the earphone based on at least the first and second impedance values; and
adjusting a characteristic related to audio output of the electronic device based on the determined type of earphone.

20. The non-transitory computer-readable recording medium of claim 19, wherein the step of determining the type of the earphone comprises:
checking a difference between the first and second impedance values;
identifying, whether the difference falls within a first range or a second range, wherein the earphone corresponds to a first type or a second type of earphone when the difference falls within the first range or the second range, respectively.
